(19) United States
(12) Patent Application Publication
(10) Pub. No.: US 2014/0280088 A1
(43) Pub. Date: Sep. 18, 2014

(54) COMBINED TERM AND VECTOR PROXIMITY TEXT SEARCH

(71) Applicant: LUMINOSO TECHNOLOGIES, INC., Cambridge, MA (US)

(72) Inventors: Robert Speer, Cambridge, MA (US); Lance Nathan, Arlington, MA (US)

(21) Appl. No.: 13/840,788

(22) Filed: Mar. 15, 2013

(51) Int. Cl. G06F 17/30

(52) U.S. Cl. CPC G06F 17/3053
USPC 707/723

(57) ABSTRACT

A system and related method are disclosed for searching a data set made up of a set of documents, a set of terms, and a vector associated with each term and each document. The method involves converting a search query to a vector in the vector space spanned by the term and document vectors, and combining vector-proximity searching and term searching to produce a set of results, which may be ranked according to various measures of relatedness to the query. Excerpts from each document in the result set may be displayed that contain the greatest term importance.

### TECHNICAL FIELD

Embodiments of the present invention relate generally to natural language processing computer methods and systems, and more particularly to the searching within vector spaces and documents.

### BACKGROUND ART

The designers of textual search algorithms face one of the more daunting tasks in computer engineering: creating algorithms that combine the speed of computer processing with the ability to mimic the human ability to perceive patterns in written language. The difficulty of this task is in the immense complexity of the latter part: to perfectly imitate human beings' facility with language is widely thought to be equivalent to perfectly imitating human intelligence. Search algorithms currently can only hope to approximate this feat well enough for the purposes of some limited range of tasks chosen by their designers. As any user of a modern search engine can attest, those approximations can produces some wonderful results when searching large bodies of text for phrases of words, but always fall short of perfection.

The traditional approach to searching for sequences of words involves extracting the important words, or key words, from the sequence, and searching for them in the documents, singly and in combination. Variations on this approach involve breaking words down to their roots and using them to search for a range of forms involving different prefixes, suffixes, and plural forms. Other variations involve trying to combine the key words into phrases to which the query can be compared more directly. An alternative approach is to convert the documents to be searched and the terms contained in the documents into a set of vectors, converting the search query into a vector, and using vector mathematics to find the vectors representing documents that are most similar to the vector representing the query, at least within the geometry of the vector space in use.

Although each of these methods has produced promising results, both methods are limited by the conditions of their implementation. Keyword searching algorithms and enhancements thereof face fundamental obstacles in the nuance and ambiguity of written language. Synonymous words could be used in a text to convey exactly the same meaning as the words entered in the query, and the keyword search could miss them entirely. Perhaps even more troublesome, keyword-based queries are prone to returning sentences that use an unrelated meaning of a polysemous word, forcing the user to read through more documents to find genuinely close matches. Fixing these issues while remaining in the keyword search model is resource-intensive and often thankless. Vector model searches, in contrast, focus on relationships between words in the corpus producing the vectors, and thus will often catch documents related to the query phrase even if the words used are synonyms of query words. For the same reason, vector searches often perform better than keyword searches at avoiding traps set by polysemous words. Vector searches, however, are limited by the assumptions underlying the creation of the applicable vector space; the interests of efficiency require the application of a few statistical rules and mathematical manipulations to approximate the vastly more complicated linguistic maneuvers of the human brain, and must necessarily miss the mark in some situations.

### SUMMARY OF THE EMBODIMENTS

It is therefore a goal of the instant invention to combine the advantages of vector model and keyword searching in a single search algorithm. It is a further goal to enhance the accuracy of existing search algorithms without sacrificing performance. It is a still further goal to provide users with an efficient and user-friendly way to search within term and document vector spaces and data sets.

A method is disclosed for searching a data set containing terms, documents, and vectors. The method is performed by at least one computer or similar electronic device. The method involves maintaining a data set in the device's memory that contains documents and terms, each of which is associated with one vector. The vectors together define a vector space. A query including at least one term from the set of terms is provided. The next step is to convert that query into a query vector in the vector space created by the vectors in the data set. Next, vector-matching results are provided by finding similar document vectors to the query vector in the vector space, which are stored in the memory of the device. The system also searches for terms from the query in the documents. The results are displayed using the electronic device's display.

In a related embodiment, the system generates the query by accepting terms input by user, including at least one term in from the data set. For at least one term in the data set contained in the query, the next step is to generate a list of terms from the data set with vectors related to the user-input term's vector; that list is then displayed. According to an additional embodiment, the vector matching search involves deriving a set of divisions of the vector space into non-overlapping sections. The section in each division containing the query vector is found, and then all the document vectors in that section are identified, and that information is saved to the device memory. In another embodiment, a number is maintained in memory for each document enumerating the divisions in which that document's shares a section with the query vector. The documents are then ranked according to that number of matches with the query vector. Another embodiment involves ranking the vector-matching or term-matching results using cosine similarity between document vectors and the query vector. Yet another embodiment involves ranking the vector-matching results using the term-searching results. Under a related embodiment, the term-searching results are weighted by term inverse document frequency prior to their use in ranking said vector-matching results. According to still another related embodiment the term-searching results are weighted by each term's associated vector's cosine similarity to the query vector before the terms are used to rank the vector matching results. A final embodiment of the method involves displaying representative excerpts of matching documents, by picking an excerpt length to use, finding the document section of that length with the most important collection of terms by some measurement of term importance, and displaying that document section.

Also disclosed is a system for searching a data set containing terms, documents, and vectors in which each document and term is associated with one vector and the vectors combine to form a vector space. The system includes one electronic device, or a set of two or more electronic devices linked by a network, whose processors are operable to perform the function of an application made up of a Data Storage Component, a Processing Component, and a Display Component. The Data Storage Component maintains the data set, vector-matching results, and term-searching results in the devices' memory. The Processing Component converts a provided query into a query vector in the vector space, produces vector-matching results by finding similar document vectors to the query vector in the vector space and searches for at least one term from the query in documents from the document set. The Display Component displays the vector-matching results and the term-searching results via the electronic devices' display means.

In a related embodiment the system has a Manual Entry Component that accepts user-input terms, including at least one term in the data set. The Processing Component is also configured to generate, for at least one user-input term in the data set, a list of terms in the data set with vectors related to the user-input term's vector; the Display Component displays that list of terms. In another embodiment, the system performs the vector-matching search by having the Processing Component derive a set of non-overlapping divisions of the vector space, find the section in each division containing the query, and identify all document vectors contained in that section. The Data Storage Component maintains the vector-matching results in memory. According to another embodiment, the Data Storage Component maintains a number in memory for each document to count the number of divisions in which that document shares a section with the query vector. The Processing Component calculates the numbers and the Display Component ranks the vector-matching results according to those numbers. In yet another embodiment, the Display Component ranks the vector-matching or term-matching results using cosine similarity between document vectors from the result set and the query vector. An additional embodiment involves the Display Component ranking the vector-matching results using the term-searching results. In a related embodiment, the Processing Component is configured to weight the term-searching results by term inverse document frequency prior to their use by the Display Component in ranking the vector-matching results. Another related embodiment involves the Processing Component weighting the term-searching results by each term's associated vector's cosine similarity to the query vector prior to its use by the Display Component to rank the vector-matching results. In a final embodiment, the Data Storage Component maintains a display excerpt length in memory. The Processing Component is configured, for each document to display, to find the portion in the document with that display excerpt length with the greatest term-importance to the query vector according to some measure of term importance. The Display Component is configured to display that portion of the document.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a flow chart illustrating some embodiments of the disclosed method.

FIG. 2 is a schematic diagram of the kind of electronic device that performs the disclosed method and comprises the disclosed system.

FIG. 3 is a schematic diagram illustrating the disclosed system and depicting a typical web-application deployment.

FIG. 4 is a schematic representation of a vector space containing document vectors and a query vector.

### DETAILED DESCRIPTION OF SPECIFIC EMBODIMENTS

The disclosed invention is a method performed by a computer or similar electronic device, which uses both term or keyword searching and vector-based searching to find the best match in a set of documents for a query. The data set it searches is a combination of documents, terms selected from the documents, and a vector space in which each document and each of the selected terms has a vector associated with it in the space. A number of methods for the creation of such a data set are known to persons skilled in the relevant art. By combining the term searching and vector searching algorithms together, this search method and system implementing it can use each searching technique to alleviate the weaknesses of the other searching technique. The end-user will benefit from the improved accuracy of the searches, without noticing a decrease in performance.

Definitions. As used in this description and the accompanying claims, the following terms shall have the meanings indicated, unless the context otherwise requires:

An “electronic device” is defined herein as including personal computers, laptops, tablets, smart phones, and any other electronic device capable of supporting an application as claimed herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry means” is a general term for all equipment coupled to an electronic device that may be used to enter data into that device. This definition includes, without limitation, keyboards, computer mouses, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “manual data entry means” is the set of all data entry devices coupled to the electronic device that permit the user to enter data into the electronic device using manual manipulation. Manual entry means include without limitation keyboards, keypads, touchscreens, track-pads, computer mouses, buttons, and other similar components.

An electronic device's “display means” is a device coupled to the electronic device, by means of which the electronic device can display images. Display means include without limitation monitors, screens, television devices, and projectors.

To “maintain” data in the memory of an electronic device means to store that data in any memory coupled to the electronic device in a form convenient for retrieval as required by the algorithm at issue, and to retrieve, update, or delete the data as needed.

A “term” is any string of symbols that may be represented as text on or by an electronic device as defined herein. In addition to single words made of letters in the conventional sense, the meaning of “term” as used herein includes without limitation a phrase made of such words, a sequence of nucleotides described by AGTC notation, any string of numerical digits, and any string of symbols whether their meanings are known or unknown to any person.

A “document” may be any collections of terms, as defined above, including books, articles, papers, web pages, and other collections of words in the colloquial sense, the nucleotide sequences of organisms, chromosomes, or plasmids, the amino acid sequences representing proteins, any subsection of any of the preceding examples, and any samples of text or textually representable patterns containing the textual data patterns the user wishes to investigate.

A “vector space” follows the mathematical definition of a vector space as a non-empty set of objects called “vectors” that is closed under the operations of vector addition and scalar multiplication. In practical terms, the vectors discussed herein will consist of lists of numbers, where each entry in the list is called a “component” of the vector. A vector with n components is described herein as an “n-dimensional vector.” A vector space is “n-dimensional” if it is spanned by a set of n vectors. For the purposes of this application, it will be assumed that the large collections of vectors with n components contemplated by this invention will span an n-dimensional space, although it is theoretically possible that the space defined by a particular collection of n-dimensional vectors as defined herein will have fewer than n dimensions; the invention would still function equally well under such circumstances. A “subspace” of an n-dimensional vector space is a vector space spanned by fewer than n vectors contained within the vector space. In particular, a two dimensional subspace of a vector space may be defined by any two orthogonal vectors contained within the vector space.

A vector's “norm” is a scalar value indicating the vector's length or size, and is defined in the conventional sense for an n-dimensional vector a as:

$$‖ a ‖ = \sqrt{{\sum }_{i = 0}^{n} {a}_{i}^{2}}$$

A vector is “normalized” if it has been turned into a vector of length 1, or “unit vector” by scalar-multiplying the vector with the multiplicative inverse of its norm. In other words, a vector a is normalized by the formula

$$\frac{a}{‖ a ‖} .$$

The system and method disclosed herein will be better understood in light of the following observations concerning the electronic devices that support the disclosed application, and concerning the nature of applications in general. An exemplary electronic device is illustrated by FIG. 2. The processor 200 may be a special purpose or a general purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, and radio frequency link or other communications channels. The communications interface in the system embodiments discussed herein facilitates the coupling of the electronic device with data entry devices 208, which can include such manual entry means 209 as keyboards, touchscreens, mouses, and trackpads, the device's display 210, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

This invention could be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 3. Web application platforms typically include at least one client device 300, which is an electronic device as described above. The client device 300 connects via some form of network connection to a network 301, such as the Internet. Also connected to the network 301 is at least one server device 302, which is also an electronic device as described above. Of course, practitioners of ordinary skill in the relevant art will recognize that a web application can, and typically does, run on several server devices 302 and a vast and continuously changing population of client devices 300. Computer programs on both the client device 300 and the server device 302 configure both devices to perform the functions required of the web application 304. Web applications 304 can be designed so that the bulk of their processing tasks are accomplished by the server device 302, as configured to perform those tasks by its web application program, or alternatively by the client device 300. However, the web application must inherently involve some programming on each device.

Many electronic devices, as defined herein, come equipped with a specialized program, known as a web browser, which enables them to act as a client device 300 at least for the purposes of receiving and displaying data output by the server device 302 without any additional programming. Web browsers can also act as a platform to run so much of a web application as is being performed by the client device 300, and it is a common practice to write the portion of a web application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a web application client 300. Thus, as a general matter, web applications require some computer program configuration both of the client device (or devices) 300 and the server device 302 (or devices). The computer program that comprises the web application component on either electronic device's system FIG. 2 configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

FIG. 1 illustrates the disclosed method, which may be performed by one electronic device as described above, or by a group of such devices connected to a network, such as the internet. The devices maintain a set of data in their memory 100. This data set includes a set of terms as defined above, a set of documents, and a set of vectors. The vectors contain data concerning the terms and documents, and together define a vector space. Ideally, the vectors should be derived from the terms and at least some of the documents by a process that results in the vectors representing the relationships between terms, between terms and documents, and between documents and each other. One way to accomplish this is to have each component of each vector correspond to a term or document in the data set. In the former case, each term will have a vector whose components consist of numbers describing the term's relationship to the other terms in the vector space, and each document will have a vector that reveals its relationship to the terms in the vector space as well. The number of dimensions in that case will be equal to the number of terms used to build the original space, and additional documents and terms can be added as other vectors whose components are based upon the new additions' relationships with the original terms. Other possibilities include having the documents in some set of documents represent the dimensions of the vector space, and having the vectors correspond to terms, or vice-versa. Whatever the choices used to build the vector space, to implement this method requires the ability to map any new sequence of terms onto the vector space as a new vector. A schematic diagram of a vector space is portrayed in FIG. 4, with document vectors (e.g. 400, 404, 405) depicted as arrows. In the interests of clarity, term vectors are not shown, and the depicted vector space has only two dimensions, but a more typical vector space for representing a set of text documents will have more than one hundred dimensions, and may have many hundreds of term and document vectors.

In the next step in the method FIG. 1, a query is provided 101. A query may be any sequence of terms as defined above, and exists for the purpose of finding sets of terms that are similar in some way to the query within a set of textual data, and may therefore be described as matches to the query. The method in this case seeks to find such matches in the documents in the data set, as revealed by searches involving the terms in the query 108 and the query's representation as a vector 102 in the vector space. The query can arrive in the system via any number of means, including user input through manual data entry means, by scanning some phrase in from a paper document, by automatic generation in some language processing algorithm, or over the internet or a similar network. To build the query's vector representation 102, the system must build a list of the terms from the original data set that are contained in the query. Those terms can be used to place the query in the vector space as a vector, either by using them as components for the query vector where the terms represent the dimensions of the vector space, or by combining vectors representing the query's terms via vector mathematics (e.g. vector addition), if the terms are vectors but not dimensions in the vector space. If neither the vectors nor the dimensions represent terms, the process of mapping will be more complicated, but presumably can follow whatever process was used to create the original vector space. Note that terms may include phrases, so the same part of the same query could contain a phrase term and a word term; whether to map each to a component or to ignore either the word or phrase is an implementation-specific decision. If the query contains no terms in the space, it may map to a null vector. The implementation can deal with this in a number of ways, including restricting the search to a keyword search within the documents, or using some kind of dictionary file to “translate” some part of the query to terms contained in the data set. The query vector 401 is depicted in the vector space facsimile in FIG. 4 as double arrow.

Once the query has been represented in vector form, the vector-similarity search algorithm FIG. 1 may take place 103. The vector similarity search 103 can take many forms, depending on the number of document vectors to be perused and the size of the space to be explored. When the space is not overly large and the number of vectors is not prohibitive, a fast and accurate way to measure vector similarity is using cosine similarity. Cosine similarity is a technique for measuring the degree of separation between any two vectors, by measuring the cosine of the vectors' angle of separation. If the vectors are pointing in exactly the same direction, the angle between them is zero, and the cosine of that angle will be 1, whereas if they are pointing in opposite directions, the angle between them is it radians, and the cosine of that angle will be −1. If the angle is greater than π radians, the cosine is the same as it is for the opposite angle; thus, the cosine of the angle between the vectors varies inversely with the minimum angle between the vectors, and the larger the cosine is, the closer the vectors are to pointing in the same direction. In the case of the query vector 401 in the vector space diagram FIG. 4, the cosines of angles between the query vector 401 and vectors pointing in nearly the same direction 404 as the query vector 401 will be nearly 1, while that for a vector pointing in nearly the opposite direction 400 will have a cosine somewhere between 0 and −1. The cosine of the angle θ between two vectors a and b may be calculated as follows:

$$cos ( θ ) = \frac{a \cdot b}{‖ a ‖ ‖ b ‖} .$$

If each vector in the vector space has been normalized, then both ∥a∥ and ∥b∥ are equal to 1, and cos(θ)=a·b. Whatever the approach used to find similar vectors, the goal is to find a list of the documents whose vectors most closely resemble the vector of the query. This approach can enable the algorithm to find documents that contain phrases with similar meaning to the query, even if the phrases' component terms are distinct from those in the query, by taking advantage of the natural language processing algorithms used to produce the vector space. Preferably, documents whose vectors do not match a certain threshold of similarity to the query vector will be excluded from the result set, and the documents that remain will be ordered by their degree of similarity to the query vector.

Once the vector search is completed, and a list of vectors produced of varying degrees of similarity to the query vector, the method FIG. 1 involves searching the documents for terms contained in the query 109. How this is performed will once again depend on the size and complexity of the data set, and on the computational resources available to perform the search. Where the size of the document set is not prohibitive for the system, each document can be searched for each term in the query. A faster search could involve searching only the documents already in the vector similarity list; another might involve a fast “presearch” of document vectors, using the documents' vector representations and their compactly stored information about term-document relationships to predict which ones are likely to contain the term at issue; the detailed search can then be limited to those documents. Another implementation choice is whether to restrict the term search to terms that are represented in the vector space, when the query might very well contain additional terms. Although only terms involved in the vector space creation are relevant for creating a vector from the query, there could be other terms in the query that are relevant to determining document matches. The search itself can follow any of the various well-known searching algorithms known to persons skilled in the relevant art. The results of the term searches are stored in the device memory. Once the vector-matching and term-searching results are assembled, the final step in the disclosed method is to display those results to the user 110. Ideally, they will be displayed to the user in a form that makes it clear which documents most closely match the query.

The instant invention may also be deployed as a system FIG. 3. The system is made up of one electronic device 300 or a set of electronic devices 300, 302 joined by a network 301 such as the internet. The device or devices 300, 302 are coupled to a display 303 for displaying the search results. Computer programs on the device or devices create an application 304, which may be a web application if more than one device is involved, or may be a stand-alone computer application. The application performs the function of a Processing Component 305, a Data Storage Component 306, and a Display Component 307. The Data Storage Component 306 is configured to maintain a data set in the device or devices' memory. The data set, as described above, contains a set of documents, a set of terms, and a set of vectors, with each term and each document associated with one vector from the set of vectors. The vectors combine to define a vector space. When a query is provided as discussed before, the Processing Component 305 is designed to convert it into a query vector within the vector space. The Processing Component 305 then finds similar document vectors to the query vector. The results of that search are maintained in the memory by the Data Storage Component 306. The Processing Component 305 also searches the document set for at least one term from the query. The Data Storage Component 306 maintains the results of the term search in memory as well. Finally, the Display Component 307 displays the results of the vector-matching and term-searching processes via the display 303. As noted above, the Display Component 307 can also organize those search results in an intuitive manner prior to display. It is also worth noting that the Processing Component 305, Display Component 307, and Data Storage Component 306 need not be separate entities or modules within a particular program as implemented. The purpose of their status as elements in the system described in this document is to establish that the processor or processors of any electronic devices 300, 302 comprising the system must be configured to perform their functions as set forth, but not to dictate the architecture of a particular implementation.

If the query is created FIG. 1 by user input using a keyboard or other manual data entry means, the system can display suggested terms to the user 119 for the completion of the query. It does so by finding a term in the query input by the user 118 that is a member of the data set, and using that term's vector and the vectors associated with the other terms to create a list of terms whose vectors are related to the query term's vector, and display related term selections 119 for the user. For the purposes of this process for generating suggested terms, two vectors are “related” if they are fairly close to each other in the vector space, relative to the other vectors. The preferred method for producing the suggested terms is to normalize all the term vectors in the vector space and then assemble them into a matrix M in which the normalized term vectors are the rows of M. Upon user entry of a term, multiply the vector v associated with the term the user has entered with M, producing a vector u=My whose components are the dot product of v with each term vector in the vector space, and therefore show which terms in the vector space have the highest cosine similarity to the query term. The term suggestions for the user can be a list of one or more of the most similar terms by that measure, in order of decreasing cosine similarity. How often to present the term suggestions is an implementation decision: the algorithm could update the suggestions with every new character or every new word, or only once when the first word is entered. Furthermore, when two terms are entered, the algorithm could be designed to present suggestions based on a phrase combining the two terms, a list of suggestions blending the lists for each individual term, or just the individual list for the final term. Another alternative once there are more than one term is to add the query term's vectors together to create a new “term vector,” normalize that vector, and multiply it by M to generate the list of cosine-similar terms as before. Finally, the user completes the creation of the query, which is accepted by the system 120. An analogous system embodiment FIG. 3 includes a Manual Entry Component 308 configured to accept terms input by user via manual data entry means, including at least one term in from the data set. The Processing Component 305 is configured to generate, for at least one user-input term in said data set, a list of terms in the data set with vectors related to the user-input term's vector, and the Display Component 307 is configured to display that list of terms.

Where the number of documents in the data set is sufficiently large to make a cosine-similarity or similarly labor-intensive comparison to each document vector impractical, a more efficient approach to vector-matching will be necessary. One such technique involves finding a set of overlapping sections of the vector space that contain the query, and finding the document vectors contained in each of those sections. To do so, the system divides the vector space into a certain number of non-overlapping sections 104 in such a way that every vector in the space is in one and only one section. The preferred approach is to generate a certain number of vectors in the vector space randomly, by using a random number generator to produce each component of each vector. For each such randomly generated vector, it is possible to place all other vectors on either side of the plane through the origin to which the vector is orthogonal, by finding out whether the dot product with the randomly generated vector is positive or negative. In this way, each vector divides the space in half, and 16 of them divide the space into 2¹⁶ sections, which is a sufficient number to be useful in the vector spaces typically searched by this algorithm. The system repeats the division process several times, with the result that each vector in the space is contained in a number of different sections that overlap with each other: one section per division. According to the preferred approach, a new set of random vectors produces a new division, and ideally a fairly large number of divisions, such as 50, should be generated. For any vector space of dimension n, this only has to be done once, and then each of the 50 divisions can be saved in a matrix made up of the randomly generated vectors that make up the division, to be used with whatever n-dimensional document and term representation space is later created.

However the divisions are produced, the next step in preparing the divisions for the query 104 is to find out where each document vector is located within each division. Continuing with the preferred example, each document added to the vector space can have its dot product taken with each vector in the division, and the results can be saved in an array or simple data type. For instance, the set of all dot products that a document vector makes with each random vector making up the division could be saved in a binary number, with one digit per random vector, with a digit value of 0 indicating that the dot product with that vector was negative, and a digit value of 1 indicating that the dot product was positive or zero. That binary number will identify the one section within the division in which the document vector can be found. Those binary numbers can used as hashes in a hash table, so that for each section, it is possible to look up all documents in the section in constant time. Of course, any unique mapping of sectors to numbers would work equally well, and the set of numbers could also be scaled as necessary for maximal efficiency within a given system. If any new document is added to the vector space later, its section in each division can be calculated and added to the hash table or similar data type. To illustrate the concept of the space division algorithm in a simplified vector space FIG. 4, the first division 402 places two vectors 404 in the same section as the query vector 401, while the second division 403 places an additional vector 405 in the same section as the query vector 401. Note that with more dimensions and more vectors, there will be many additional ways for sections to overlap. For the next step in the method FIG. 1, the query is located within each division 105. Using the preferred method described above, when a query is entered, its vector's dot product with each of the random vectors in a division can be taken, producing the binary number (or any other datum as convenient for the implementation) representing the section in that division that contains the query vector. The final step for each division is to find the other vectors in the same section as the query vector 106. If the preferred example's approach is used, the system can very quickly retrieve the vectors in the same section using the hash table or other fast-lookup data type. The vectors thus found must be saved to memory 107. Lastly, this set of steps must be repeated for each division 108. This approach rapidly produces a list of documents that are somewhat closely associated with the query vector; as the division vectors for any given vector space may be created for all users before they start to use the software, the only computationally intense task should be the initial categorization of each document within the divisions, which takes as long, per document, as it takes to obtain the categorization of the query. Once that has been completed, the search itself should proceed very rapidly for each new query.

According to a related system embodiment FIG. 3, the Processing Component 305 is configured to derive the set of divisions of the vector space as described above, and to find the section containing the query vector in each division. The Processing Component 305 also identifies the document vectors that occupy the same section in each division. As noted above, in practice the document vectors that occupy each section of each divisions can be calculated once and saved in a hash table or other data type that similarly allows rapid lookup, to greatly improve the efficiency of this algorithm. The Data Storage Component 306 saves the results of this search to the memory; in other words, the identification of each document that shares a section with the query vector can be saved in the memory.

The above division method FIG. 1 also suggests a way to rank the matching documents: if a document is in the same section as the query over multiple divisions, it suggests that document has some heightened degree of similarity to the query. To exploit this fact, the system can maintain a number in memory for each document that counts the number of appearances in the same section as the query vector, by incrementing 111 every time the document vector and the query vector have a matching division section. For example, for each new query, the document vector's associated number can be initialized to zero. For each division, all documents whose section (e.g. whose dot-product binary number in the above example) matches the query vector's section will have one added to their number 111. The documents are then ranked 112 according to their associated numbers. In the schematic diagram of the vector space FIG. 4, one set of vectors 404 is located in the same section as the query vector 401 in the first division 402 of the space. In the second division of the space 403, the same vectors 404 share a section with the query vector 401, but a new vector 405 shares the section as well. According to this method's approach, the vectors 404 that share sections with the query vector 401 in two divisions 402, 403 will be ranked higher than the vector 405 that only shares a section with the query vector 401 in one division 403. As noted before, the results could be ordered according to these rankings so the user would see the highest ranking, and thus likely the most closely matching, documents first. Especially low scoring documents could be eliminated from the result set in some implementations.

In an analogous system embodiment FIG. 3, the Data Storage Component 306 maintains a number for each document in the memory. The number measures the number of divisions for which each document's vector shares a section with the query vector, as calculated by the Processing Component 305. To accomplish this, the Data Storage Component 306 can initialize each document vector's number to zero upon the entry of a new query. Then when the Processing Component 305 finds the documents sharing a section with the query vector for each division, it increments each such document's number by one, and the new number is stored by the Data Storage Component 306. When the Processing Component 305 has found the document matches from each division, each document's number will reflect the number of times the document has shared a section with the query vector, and the Display Component 307 can order the documents according to the number or use it to eliminate insufficiently strong matches.

Another way to rank documents within both result sets FIG. 1 is by calculating the cosine similarity between the vector of each document within the result set and the query vector 113. The cosine similarity technique and calculation is described above; to sort the document vectors by cosine similarity to the query requires calculating the cosine similarity between the query and each document, and then ordering the cosine similarities thus calculated by magnitude. As noted above, cosine similarity is an excellent way to find the degree of relatedness between two vectors, particularly where the significance of the vector representations is encoded in their directions in the space, as opposed to their lengths. The drawback of using cosine similarity to find related vectors at the outset 103 is the necessity of running the cosine similarity calculation on every one of the document vectors for each new query. When compared to the space-division algorithm described above, which has an initial calculation per document during initialization, followed by a very rapid look-up protocol for each new query, cosine similarity is a very expensive method for finding related documents. However, once the space division method or a similarly efficient approach, combined with the term search algorithm, has produced a set of more or less related documents 103, relatively few calculations would be required to sort them by degree of relatedness using cosine similarity 113. The analogous system embodiment involves configuring the Display Component 307 to rank vector-matching or term-matching results using cosine similarity between the document vectors and the query vector.

Cosine similarity has one vital limitation when dealing with textual spaces: it is only as good as the vector space's encoding of meaningful relationships between terms and documents. Although modern natural language processing algorithms are producing ever more sophisticated ways of capturing semantic relationships mathematically, no simple model of such a complex subject can be perfect. The use of a term search in parallel with the vector-matching algorithm furnishes a way to overcome the limitations of the vector model in use. One way to accomplish this is by listing the term-search and vector-matching results together in a result set, as described above. Another approach is to present the vector-matching results, ranked and sorted by term-search results 114. To illustrate, imagine that the vector-matching algorithm has produced two documents that are related to the query. If one document contains more terms from the query, that document may be more closely related to the query than the other document. Thus, the document containing more query terms could be presented higher on the list of result sets than the document with fewer query terms. Greater care in assessing the importance of different terms can greatly improve this method. The discovery in a document of a phrase consisting of the entire query, for instance, could be given greater weight than the discovery of a single term from the query; phrases that make up part but not all of the query might also be more significant than some words alone. Analysis of the query's syntax might reveal one or two words that the sentence structure suggests are more vital to the query's meaning as well. How the terms are counted in documents is also very important: an ideal approach would give a higher score to a small document that uses a term frequently than to a large document that uses the same term sparsely, even if the two documents contain the same absolute quantity of that term. To distinguish between those two documents, the system could divide the total number of occurrences of a term by the maximum frequency of any term in the document, which avoids the erroneous conclusion that a term is important to a document despite appearing infrequently, merely because the document is long. Persons skilled in the art will be aware of many other techniques for measuring term frequency. The analogous system embodiment involves configuring the Display Component 307 to rank the results of the vector-matching algorithm using the term-searching results.

Some terms in the query will be distributed throughout the document set, while others will be concentrated in a few documents. The latter kind of term is likely to be more useful in finding documents whose meanings more closely match that of the query. To accentuate those less uniformly distributed terms, the system can multiply each term by its inverse document frequency, or idf 115. Idf is number that will be large when the term is found only in a small proportion of documents in the set, and small when the term is found in many documents. Consequently, multiplying term frequency, or a number derived from it, by idf shrinks that number for terms that are spread out evenly, making the terms that are less evenly distributed stand out. Idf is generally rendered as follows, for a term t, and a set of documents D whose members are denoted d:

$$\text{:} Log ( \frac{\vert D \vert}{\{ d ∈ D ; t ∈ d \}} )$$

where |D| is the number of documents in the document set, and {dεD;tεd} is the number of documents that contain any appearances of t. This number can also be modified to reflect a term's scarcity within a larger corpus of documents, such as GOOGLE® books, which provides term-frequency statistics for its set of documents in its ngrams data set. If the frequency in that larger collection of documents is called gfrequency, for example, idf could be multiplied by

$$\frac{1}{\sqrt{gfrequency}} .$$

For a multiple-word phrase, it may be desirable to estimate the phrase's frequency instead of looking it up in a very large list of GOOGLE® ngrams. If the phrase can be broken into shorter phrases with raw frequencies a and b, one can overestimate the phrase's gfrequency as

$$\frac{a \times b}{a + b} .$$

This operation is chosen because it scales with a and b and follows the associative law, so it can be repeated until the phrase is broken down into single words, and therefore only the frequencies of single words need to be readily available in the computer's memory. The resulting estimate will usually be higher than the actual frequency, but overestimating the frequency tends to lead to better results than underestimating it. It would also be possible to calculate a term's idf over the larger corpus, using the same statistical measures for calculating idf over the document set within the vector space. The analogous system embodiment involves configuring the Processing Component 305 to weight the term-searching results by term idf with or without the additional calculations as described above, before they are used to rank the vector matching results by the Display Component 307.

If the vector space used in the implementation of this method contains vectors for individual terms, then those vectors provide still another way to measure a term's importance to the query in the context of the document set. In particular a given term's impact on the ranking of related documents can be weighted by the term's vector's cosine similarity to the query vector 116. Once again, this takes advantage of the vector space's encoding of term and document relationships. For instance, a query might contain two words which the structure of the query suggests are equally important, and whose distributions throughout the documents are about the same. However, one term's associations with other terms and with documents results in its vector being very close to the query's vector. The reasons why the two vectors are close to each other could be a complex web of relationships to other terms that would be hard to capture through more conventional calculations on the document set. A document containing a high frequency of appearances for that closely related term might be more closely related to the query in a number of subtle ways that perhaps would be clear to a person reading the document, even if the mathematical relationships involve were complex. Thus, an embodiment of the invention that accounted for term cosine similarity to query vectors could bring to a user's attention some distinctions between documents that other algorithms would miss. The analogous system embodiment involves configuring the Processing Component 305 to weight the term-searching results using each term's associated vector's cosine similarity to the query vector.

A final consideration is the manner in which the matching documents are displayed to the user 110. There are many possible ways to do this, including a simple ordered list of document titles. However, it is particularly useful to present each document by showing the portion of the document that most closely matches the query to the user 117. The preceding paragraphs list a number of ways to determine each term's importance to the query. Finding the most significant portion of the document involves locating the portion that has the greatest overall importance score: that is, for a given excerpt length, what portion of the document with a character count of that length contains the most term importance, according to some measure of term importance. According to this approach, for instance, a paragraph containing multiple instances of moderately important terms would be approximately as important as a paragraph containing a single instance of a very important term. In practice, this requires choosing the size in character count or a similar measure of the excerpts to be displayed, then using a search algorithm to find sections of that length in the document that contain query terms, adding up the importance of the terms in each such section, and using a sorting algorithm to find the section with the highest importance score. Another approach could involve creating vectors out of the excerpts and measuring those vectors' cosine similarity to the query vector. The display 117 of the chosen excerpt could also highlight the query terms found in the excerpt. In the analogous system embodiment, the memory contains a number indicating the length of the document sections to be displayed, in terms of character count or some similar concept. This number is maintained by the Data Storage Component 306. The Processing Component 305 follows an algorithm as described above to find the portion of each document that contains that length in characters or whatever is used as the unit of measurement that has the greatest term-importance to the query vector, as described above. The Display Component 307 displays that excerpt for each document in the results list. The Display Component 307 could also highlight the terms that conferred importance to the displayed document portion, using different colors or fonts.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A method performed by at least one electronic device, said device having a processor, a memory, and a display means, for searching a data set containing terms, documents, and vectors, comprising:
maintaining in said memory a data set comprising a set of documents, a set of terms, and a set of vectors, such that each term and each document is associated with one vector from said set of vectors, said vectors together defining a vector space;
providing a query comprising at least one term from said set of terms;
converting said query into a query vector in said vector space;
producing vector-matching results by finding similar document vectors to said query vector in said vector space and maintaining the identity of said document vectors in said memory;
producing term-searching results by searching documents from said document set for at least one term comprising said query and maintaining the results of said searching in said memory; and
displaying said vector-matching results and said term-searching results via said display means.

2. A method according to claim 1, wherein the step of providing a query comprises:
accepting terms input by user via manual data entry means coupled to said electronic device, including at least one term in said data set;
for at least one user-input term in said data set, generating a list of terms in said data set with vectors related to said user-input term's vector; and
displaying said list of terms via said display.

3. A method according to claim 1, wherein producing said vector-matching results comprises:
deriving a set of divisions of said vector space, each division dividing said vector space into sections such that each vector in said vector space is contained in one and only one section;
for each said division of said vector space, producing vector-matching results by:
identifying the section in said division containing said query vector;
identifying all vectors contained in said section that are associated with documents from said document set; and
maintaining said vector-matching results in said memory.

4. A method according to claim 2, further comprising:
maintaining in said memory a set of numbers representing for each document in said data set the number of said divisions in which said document's vector is contained in said section; and
ranking said vector-matching results according to said numbers.

5. A method according to claim 1 further comprising ranking said vector-matching or term-matching results using cosine similarity between said vectors associated with documents in said result set and said query vector.

6. A method according to claim 1 further comprising ranking said vector-matching results using said term-searching results.

7. A method according to claim 5 wherein said term-searching results are weighted by term inverse document frequency prior to their use in ranking said vector-matching results.

8. A method according to claim 5 wherein said term-searching results are weighted by each term's associated vector's cosine similarity to said query vector prior to the use of said term-searching results in ranking said vector-matching results.

9. A method according to claim 1, wherein displaying said vector-matching results comprises:
maintaining in said memory a display excerpt length;
for each document to display, finding the portion with said display excerpt length of said document with the greatest term-importance to the query vector; and
displaying said portion of said document.

10. A system for searching a data set containing terms, documents, and vectors, comprising one electronic device, or a set of two or more electronic devices linked by a network, each electronic device having display means, a memory, and a processor, said processors together or singly operable to execute instructions to perform functions comprising:
A Data Storage Component, configured to:
maintain in said memory a data set comprising a set of documents, a set of terms, and a set of vectors, such that each term and each document is associated with one vector from said set of vectors, said vectors together defining a vector space;
maintain vector-matching results in said memory; and
maintain term-searching results in said memory; and
A Processing Component, configured to:
convert a provided query into a query vector in said vector space;
produce said vector-matching results by finding similar document vectors to said query vector in said vector space; and
produce said term-searching results by searching documents from said document set for at least one term comprising said query; and
A Display Component, configured to:
display said vector-matching results and said term-searching results via said display means.

11. A system according to claim 10, further comprising a Manual Entry Component configured to accept terms input by user via manual data entry means coupled to said electronic device, including at least one term in said data set and wherein said Processing Component is configured to generate, for at least one user-input term in said data set, a list of terms in said data set with vectors related to the user-input term's vector, and wherein said Display Component is configured to display said list of terms via said display.

12. A system according to claim 10, wherein:
said Processing Component is configured to:
derive a set of divisions of said vector space, each division dividing said vector space into sections such that each vector in said vector space is contained in one and only one section;
produce said vector-matching results for each said division of said vector space by identifying the section in said division containing said query vector and identifying all vectors contained in said section that are associated with documents from said document set; and
said Data Storage Component is configured to:
maintain said vector-matching results in said memory.

13. A system according to claim 12, wherein:
said Data Storage Component is configured to maintain in said memory a set of numbers representing for each document in said data set the number of said divisions in which said document's vector is contained in said section;
said Processing Component is configured to calculate said numbers; and
said Display Component is configured to rank said vector-matching results according to said numbers.

14. A system according to claim 10 wherein said Display Component is further configured to rank said vector-matching or term-matching results using cosine similarity between said document vectors and said query vector.

15. A system according to claim 10 wherein said Display Component is further configured to rank said vector-matching results using said term-searching results.

16. A system according to claim 15 wherein said Processing Component is further configured to weight said term-searching results by term inverse document frequency prior to the use by said Display Component of said term-searching results in ranking said vector-matching results.

17. A system according to claim 15 wherein said Processing Component is further configured to weight said term-searching results by each term's associated vector's cosine similarity to said query vector prior to the use by said Display Component of said term-searching results in ranking said vector-matching results.

18. A system according to claim 10 wherein:
said Data Storage Component is configured to maintain in said memory a display excerpt length;
said Processing Component is configured, for each document to display, to find the portion with said display excerpt length of said document with the greatest term-importance to the query vector; and
said Display Component is configured to display said portion of said document.
